(19) United States
(12) Patent Application Publication
(10) Pub. No.: US 2024/0142043 A1
(43) Pub. Date: May 2, 2024

(54) SYSTEM FOR MOUNTING MULTIPLE DISPLAYS WITHIN A CAB OF AN AGRICULTURAL VEHICLE

(71) Applicant: CNH Industrial America LLC, New Holland, PA (US)

(72) Inventors: Roy A. Bittner, Reedsville, WI (US); Steven Winkel, Elkhart Lake, WI (US); John Myers, Sheboygan, WI (US)

(21) Appl. No.: 17/977,261

(22) Filed: Oct. 31, 2022

(51) Int. Cl. F16M 11/06; F16M 13/02

(52) U.S. Cl. CPC F16M 11/06; F16M 13/02

(57) ABSTRACT

A system includes a base support positioned within a cab of an agricultural vehicle, a first support arm extending between a first proximal end and a first distal end, a second support arm extending between a second proximal end and a second distal end, a first display coupled to the first distal end, and a second display coupled to the second distal end. The first proximal end is rotatably coupled to the base support about a first axis and the second proximal end is rotatably coupled to the base support about a second axis. The second support arm is rotatable about the second axis along a second path independently of rotation of the first support arm about the first axis along a first path, where the entire first path is spaced radially inwardly from the second path relative to the second axis.

### FIELD OF THE INVENTION

The present disclosure relates generally to agricultural vehicles and, more particularly, to a system for mounting multiple displays within a cab of an agricultural vehicle.

### BACKGROUND OF THE INVENTION

Agricultural implements, such as planters, seeders, tillage implements, sprayers, and/or the like, are typically configured to perform an agricultural operation within a field, such as a planting/seeding operation, a tillage operation, a spraying operation and/or the like. For instance, agricultural sprayers apply an agricultural substance (e.g., a pesticide) onto crops as the sprayer is traveling across a field. To facilitate such travel, sprayers are configured as self-propelled vehicles or implements towed behind an agricultural tractor or other suitable agricultural vehicle. A typical sprayer includes one or more boom assemblies on which a plurality of spaced apart nozzles is mounted. Each nozzle is configured to dispense or otherwise spray the agricultural substance onto underlying crops and/or weeds.

The agricultural vehicle may include any suitable number of user interfaces, such as display screens, buttons, knobs, wheels, joysticks, speakers, lights, and/or the like, within a cab of the agricultural vehicle which may aid an operator in monitoring and/or controlling the performance of the agricultural operation. However, when there are multiple display screens, it may be difficult to allow flexible positioning of at least some of the display screens without obstructing the view of the other display screens or contacting the other display screens.

Accordingly, a system for mounting multiple displays within a cab of an agricultural vehicle would be welcomed in the technology.

### BRIEF DESCRIPTION OF THE INVENTION

Aspects and advantages of the invention will be set forth in part in the following description, or may be obvious from the description, or may be learned through practice of the invention.

In one aspect, the present subject matter is directed to a system for mounting multiple displays within a cab of an agricultural vehicle. The system may include a base support positioned within the cab. The system may further include a first support arm extending between a first proximal end and a first distal end, with the first proximal end being rotatably coupled to the base support about a first axis. Similarly, the system may include a second support arm extending between a second proximal end and a second distal end, with the second proximal end being rotatably coupled to the base support about a second axis. More particularly, the second support arm may be rotatable about the second axis along a second path independently of rotation of the first support arm about the first axis along a first path, where the entire first path may be spaced radially inwardly from the second path relative to the second axis. Additionally, the system may include a first display coupled to the first distal end of the first support arm relative to the base support, and a second display coupled to the second distal end of the second support arm relative to the base support.

In another aspect, the present subject matter is directed to an agricultural vehicle having a cab and a base support positioned within the cab. The vehicle may further include a first support arm extending between a first proximal end and a first distal end, with the first proximal end being rotatably coupled to the base support about a first axis. Similarly, the vehicle may include a second support arm extending between a second proximal end and a second distal end, with the second proximal end being rotatably coupled to the base support about a second axis. More particularly, the second support arm may be rotatable about the second axis along a second path independently of rotation of the first support arm about the first axis along a first path, where the entire first path may be spaced radially inwardly from the second path relative to the second axis. Additionally, the vehicle may include a first display coupled to the first distal end of the first support arm relative to the base support, and a second display coupled to the second distal end of the second support arm relative to the base support.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 illustrates a perspective view of one embodiment of an agricultural sprayer in accordance with aspects of the present subject matter;

FIG. 2 illustrates a perspective view of a system for mounting multiple displays within a cab in accordance with aspects of the present subject matter;

FIGS. 3A and 3B illustrate various front views of the system for mounting multiple displays within the cab shown in FIG. 2 in accordance with aspects of the present subject matter, particularly illustrating different relative alignments of pivot axes of support arms of the system;

FIGS. 4A-4C illustrate various side views of the system for mounting multiple displays within the cab shown in FIG. 2 in accordance with aspects of the present subject matter, particularly illustrating different relative alignments of pivot axes of support arms of the system; and

FIGS. 5A-5C illustrate various top-down views of the system for mounting multiple displays within the cab shown in FIG. 2 in accordance with aspects of the present subject matter, particularly illustrating different relative alignments of travel paths of support arms of the system corresponding to different relative alignments of pivot axes of the support arms.

Repeat use of reference characters in the present specification and drawings is intended to represent the same or analogous features or elements of the present technology.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

In general, the present subject matter is directed to a system for mounting multiple displays within a cab of an agricultural vehicle. For instance, two separate support arms may be positioned within the cab, where a first end of each support arm is rotatably coupled to a common base support, such as an arm of an operator chair within the cab, and where the second end of each arm is configured to support a respective display. In some instances, the rotational axes of the support arms are coaxial. However, in other instances, the rotational axes may be spaced apart. The support arms are advantageously configured such that the support arms may move past each other without interfering with each other at any point along their travel paths. Further, the support arms are configured such that display screens of both displays are always visible. In some instances, a further display having a further display screen may be supported within the cab, such as on a structural pillar of the cab, where the displays of the disclosed system also do not visually obstruct the further display screen.

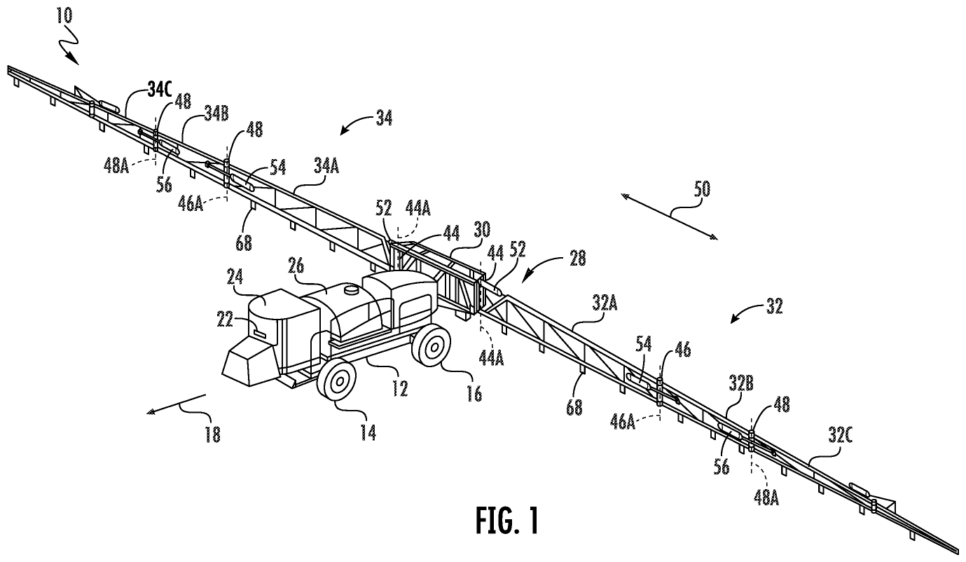

Referring now to FIG. 1, a perspective view of an agricultural work vehicle, particularly an agricultural sprayer 10 is illustrated in accordance with aspects of the present subject matter. In the illustrated embodiment, the agricultural sprayer 10 is configured as a self-propelled agricultural sprayer. However, in alternative embodiments, the agricultural sprayer 10 may be configured as any other suitable type of agricultural sprayer 10 configured to perform agricultural spraying operations, such as a tractor or other vehicle configured to haul a spraying or application implement.

As shown in FIG. 1, the agricultural sprayer 10 may include a chassis or frame 12 configured to support or couple to a plurality of components. For example, a pair of steerable front wheels 14 (only one of which is shown) and a pair of driven rear wheels 16 (only one of which is shown) may be coupled to the frame 12. The wheels 14, 16 may be configured to support the agricultural sprayer 10 relative to the ground and move the agricultural sprayer 10 in a direction of travel (e.g., as indicated by arrow 18 in FIG. 1) across a field. In this regard, the agricultural sprayer 10 may include an engine (not shown) and a transmission (not shown) configured to transmit power from the engine to the wheels 14, 16. However, it should be appreciated that, in further embodiments, the front wheels 14 of the agricultural sprayer 10 may be driven in addition to or in lieu of the rear wheels 16. The frame 12 may also support an operator's cab 24 that houses various control or input devices (e.g., levers, pedals, control panels, buttons, and/or the like) for permitting an operator to control the operation of the sprayer 10. For instance, as shown in FIG. 1, the agricultural sprayer 10 may include a human-machine or user interface 22, as will be described below in greater detail, for displaying message windows and/or alerts to the operator and/or for allowing the operator to interface with the vehicle's controller or computing system. In one embodiment, the user interface 22 may include joysticks, buttons, knobs and/or any other suitable input devices that allow the operator to provide user inputs to an associated controller or computing system.

Furthermore, the frame 12 may also support one or more tanks 26 and a frame or boom assembly 28 mounted on the frame 12. Each tank 26 is generally configured to store or hold an agricultural product, such as a pesticide, a nutrient, and/or the like. A plurality of nozzle assemblies 68 are mounted on the boom assembly 28 and configured to selectively dispense the agricultural product stored in the associated tank 26 via the nozzles onto underlying plants and/or soil. The nozzle assemblies 68 are generally spaced apart from each other on the boom assembly 28 along a lateral direction 50. Furthermore, fluid conduits (not shown) may fluidly couple the nozzle assemblies 68 to the tank(s) 26. Each nozzle assembly 68 may include a nozzle valve (not shown) and an associated spray tip or spray nozzle (not shown). In several embodiments, the operation of each nozzle valve may be individually controlled by an associated controller or computing system such that the valve regulates the flow rate and/or other spray characteristic of the agricultural product through the associated spray nozzle.

The boom assembly 28 of the agricultural sprayer 10 may generally be movable between a working or unfolded position (FIG. 1) and a transport or folded position (not shown). In the working position, various sections of the boom assembly 28 are fully extended such that the boom assembly 28 extends over as wide a section of a field as possible. In the transport position, the various sections of the boom assembly 28 are fully retracted to reduce the width of the sprayer 10 for travel. As will be described below, the boom assembly 28 may include a plurality of fold actuators coupled between adjacent boom sections of the boom assembly 28 for moving the boom assembly 28 between the working and transport positions.

As shown in FIG. 1, in one embodiment, the boom assembly 28 includes a central boom section 30, a left boom arm 32, and a right boom arm 34. The left boom arm 32 includes a left inner boom section 32A pivotably coupled to the central boom section 30, a left middle boom section 32B pivotably coupled to the left inner boom section 32A, and a left outer boom section 32C pivotably coupled to the left middle boom section 32B. Similarly, the right boom arm 34 includes a right inner boom section 34A pivotably coupled to the central boom section 30, a right middle boom section 34B pivotably coupled to the right inner boom section 34A, and a right outer boom section 34C pivotably coupled to the right middle boom section 34B. Each of the inner boom sections 32A, 34A is pivotably coupled to the central boom section 30 at pivot joints 44. Similarly, the middle boom sections 32B, 34B are pivotally coupled to the respective inner boom sections 32A, 34A at pivot joints 46 while the outer boom sections 32C, 34C are pivotably coupled to the respective middle boom sections 32B, 34B at pivot joints 48.

As is generally understood, pivot joints 44, 46, 48 may be configured to allow relative pivotal motion between adjacent boom sections of the boom assembly 28. For example, the pivot joints 44, 46, 48 may allow for articulation of the various boom sections between a fully extended or working position (e.g., as shown in FIG. 1), in which the boom sections are unfolded along the lateral direction 50 to allow for the performance of an agricultural spraying operation, and a transport position (not shown), in which the boom sections are folded inwardly to reduce the overall width of the boom assembly 28 along the lateral direction 50. It should be appreciated that, although the boom assembly 28 is shown in FIG. 1 as including a central boom section and three individual boom sections coupled to each side of the central boom sections, the boom assembly 28 may generally have any suitable number of boom sections. For example, in other embodiments, each boom arm 32, 34 may include four or more boom sections or less than three boom sections.

Additionally, as shown in FIG. 1, the boom assembly 28 may include inner fold actuators 52 coupled between the inner boom sections 32A, 34A and the central boom section 30 to enable pivoting or folding between the fully-extended working position and the transport position. For example, by retracting/extending the inner fold actuators 52, the inner boom sections 32A, 34A may be pivoted or folded relative to the central boom section 30 about a pivot axis 44A defined by the pivot joints 44. Moreover, the boom assembly 28 may also include middle fold actuators 54 coupled between each inner boom section 32A, 34A and its adjacent middle boom section 32B, 34B and outer fold actuators 56 coupled between each middle boom section 32B, 34B and its adjacent outer boom section 32C, 34C. As such, by retracting/extending the middle and outer fold actuators 54, 56, each middle and outer boom section 32B, 34B, 32C, 34C may be pivoted or folded relative to its respective inwardly adjacent boom section 32A, 34A, 32B, 34B about a respective pivot axis 46A, 48A. When moving to the transport position, the boom assembly 28 and fold actuators 52, 54, 56 are typically oriented such that the pivot axes 44A, 46A, 48A are parallel to the vertical direction 58 and, thus, the various boom sections 32A, 34A, 32B, 34B, 32C, 34C of the boom assembly 28 are configured to be folded horizontally (e.g., parallel to the lateral direction 50) about the pivot axes 44A, 46A, 48A to keep the folding height of the boom 28 as low as possible for transport. However, the pivot axes 44A, 46A, 48A may be oriented along any other suitable direction.

It should be appreciated that the specific configuration of the agricultural sprayer 10 described above and shown in FIG. 1 is provided only to place the present subject matter in an exemplary field of use. In this regard, it should be apparent to those of ordinary skill in the art that the present subject matter may be readily adaptable to any manner of machine configuration that is consistent with the disclosure provided herein.

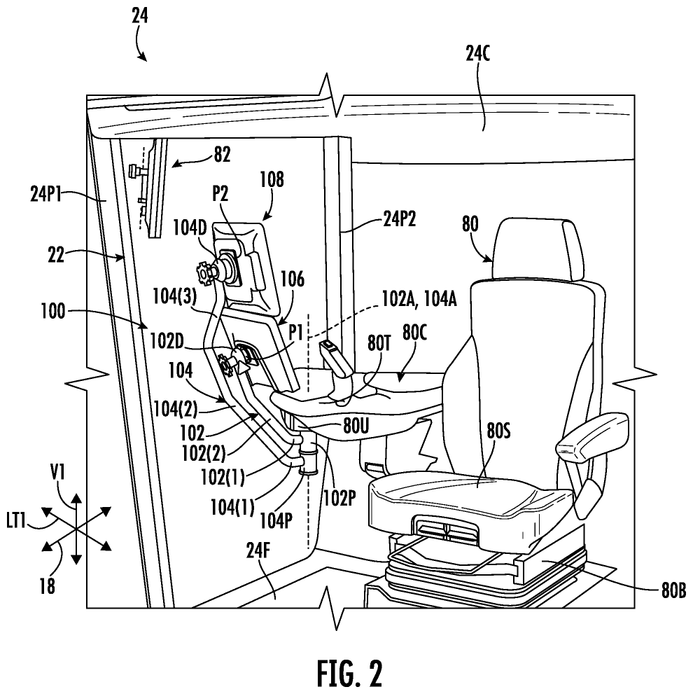

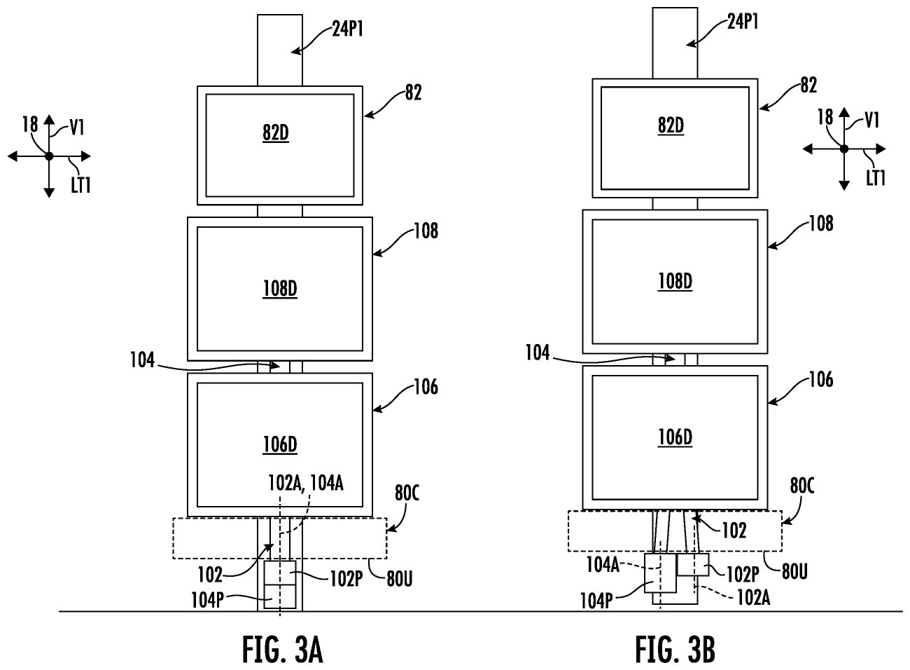

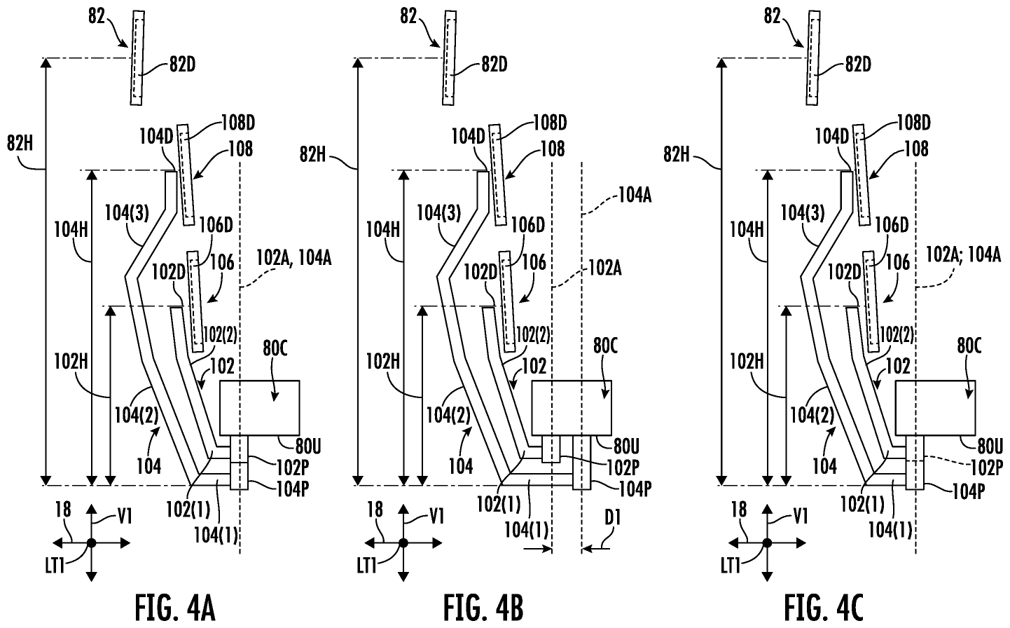

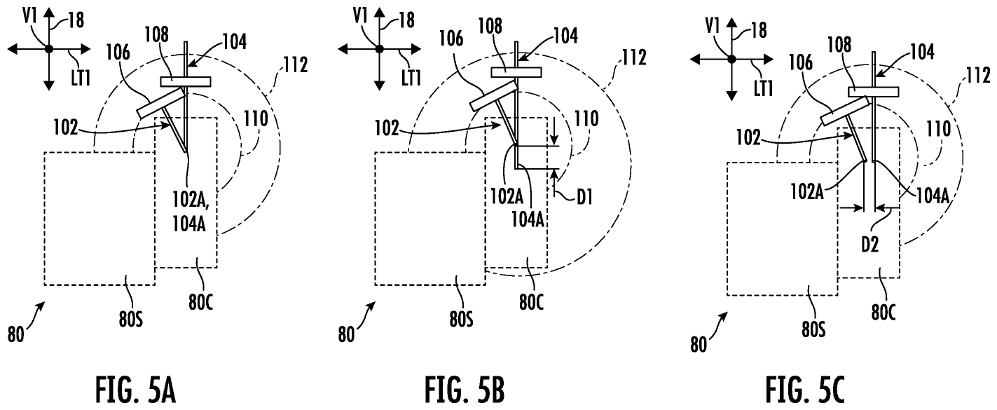

Referring now to FIGS. 2-5C, various views of a system 100 for mounting multiple displays within the cab 24 are illustrated in accordance with aspects of the present subject matter. More particularly, FIG. 2 illustrates a perspective view of the system 100 within a cab, such as cab 24 of the sprayer 10 shown in FIG. 1. Further, FIGS. 3A and 3B illustrate various front views of the system 100 shown in FIG. 2, particularly illustrating different relative alignments of pivot axes of the system 100. Moreover, FIGS. 4A-4C illustrate various side views of the system 100 shown in FIG. 2, particularly illustrating the different relative alignments of pivot axes of the system 100. Additionally, FIGS. 5A-5C illustrate various top-down views of the system 100 shown in FIG. 2, particularly illustrating different relative alignments of travel paths of support arms of the system 100 corresponding to different relative alignments of pivot axes of the system 100.

As particularly shown in FIG. 2, the cab 24 may generally include a floor 24F, a roof or ceiling 24C, one or more pillars, such as a front pillar 24P1 and a rear pillar 24P2, for supporting the ceiling 24C relative to the floor 24F, and an operator chair 80. The operator chair 80 includes a seat 80S for supporting the operator's legs and back, a base 80B for supporting the seat 80S relative to the floor 24F of the cab 24, and a control armrest 80C coupled to the seat 80S and/or the base 80B. In some instances, the base 80B may be an adjustable base that is at least vertically adjustable for different heights of a user and/or adjustable based on the weight of the user (e.g., for damping motion from bumps, etc.). In some instances, the control armrest 80C may have one or more input devices (e.g., levers, control panels, joysticks, buttons, knobs, etc.) of the user interface 22 that allow the operator to provide user inputs to an associated controller or computing system. In some embodiments, the user interface 22 further includes a display unit 82 supported within the cab 24, such as on the front pillar 24P1, where the display unit 82 includes a display screen 82D that is controllable by an associated controller or computing system. The display screen 82D may be any suitable type of display screen (e.g., an LCD screen, an LED screen, a touch screen, and/or the like).

In accordance with aspects of the present subject matter, the cab 24 may further include a system 100 for mounting multiple other displays within the cab 24. For instance, the system 100 includes a plurality of support arms, such as at least a first support arm 102 and a second support arm 104, and a plurality of display screen units of the user interface 22, such as a first display screen unit 106 and a second display screen unit 108. The first support arm 102 extends between a proximal end 102P and a distal end 102D. Similarly, the second support arm 104 extends between a proximal end 104P and a distal end 104D. In one embodiment, the proximal ends 102P, 104P of the support arms 102, 104 are rotatably coupled to the same base support within the cab 24, such as the operator chair 80. For instance, the proximal ends 102P, 104P of the support arms 102, 104 are rotatably coupled to the control armrest 80C of the operator chair 80, such that the first support arm 102 is rotatable about a first rotational axis 102A and the second support arm 104 is rotatable about a second rotational axis 104A. In some embodiments, the proximal ends 102P, 104P of the support arms 102, 104 are particularly rotatably coupled to an underside 80U of the control armrest 80C, proximate an end of the armrest 80C furthest from a seatback of the seat 80S. However, it should be appreciated that the support arms 102, 104 may instead be coupled to a top side 80T of the control armrest 80C or at any other suitable location. Generally, by rotatably coupling the support arms 102, 104 to the operator chair 80, the support arms 102, 104 may move with adjustment of the chair 80, ensuring a consistent viewing angle for different operators. As will be described below in greater detail, in one embodiment, the first and second rotational axes 102A, 104A extend parallel to each other. For instance, the rotational axes 102A, 104A may extend along or parallel to a vertical direction V1. As will further be described below in greater detail, in at least one embodiment, the first support arm 102 is rotatable about the first rotational axis 102A independently of rotation of the second support arm 104 about the second rotational axis 104A.

The first support arm 102 may be configured to support the first display screen unit 106 relative to the control armrest 80C and the second support arm 104 may be configured to support the second display screen unit 108 relative to the control armrest 80C. For instance, the distal end 102D of the first support arm 102 may be coupled to the first display screen unit 106, and the distal end 104D of the second support arm 104 may be coupled to the second display screen unit 108. For example, the distal ends 102D, 104D of the support arms 102, 104 may include mounting plates P1, P2 configured to be coupled to respective mounting surfaces of the display screen units 106, 108 (e.g., rear sides of the display screen units 106, 108). In some instances, the distal ends 102D, 104D of the support arms 102, 104 may be movably (e.g., rotatably) coupled to the display screen units 106, 108, such as by ball joints and/or the like, such that the display screen units 106, 108 may rotate relative to the support arms 102, 104. However, in some embodiments, the display screen units 106, 108 may be fixed relative to the support arms 102, 104. Each of the display screen units 106, 108 has a display screen 106D, 108D that is controllable by an associated controller or computing system. The display screens 106D, 108D may be any suitable type of display screen (e.g., an LCD screen, an LED screen, a touch screen, and/or the like).

The support arms 102, 104 may be configured such that they do not interfere with each other or the control armrest 80C while rotating about their respective axis 102A, 104A. For instance, as shown in FIGS. 2 and 4A-4C, the first support arm 102 has a primary segment 102(1) and a secondary segment 102(2), where the primary segment 102(1) extends between the proximal end 102P and the secondary segment 102(2), and the secondary segment 102(2) extends between the primary segment 102(1) and the distal end 102D. The primary segment 102(1) extends substantially in the radial direction relative to the axis 102A, whereas the secondary segment 102(2) extends at least away from the primary segment 102(1) in the vertical direction V1. For instance, in one embodiment, the secondary segment 102(2) extends both increasingly outwardly in the radial direction relative to the first rotational axis 102A, such that the secondary segment 102(2) does not contact the control armrest 80C in the radial direction, and increasingly outwardly (e.g., upwardly) in the vertical direction V1 from the primary segment 102(2). In one embodiment, the distal end 102D of the first support arm 102 is the furthest portion of the first support arm 102 in the radial direction from the axis 102A.

The second support arm 104 similarly has a primary segment 104(1), a secondary segment 104(2), and a third segment 104(3), where the primary segment 104(1) extends between the proximal end 104P and the secondary segment 104(2), the secondary segment 104(2) extends between the primary segment 104(1) and the third segment 104(3), and the third segment 104(3) extends between the secondary segment 104(2) and the distal end 104D. The primary segment 104(1) extends substantially in the radial direction relative to the second rotational axis 104A, whereas the secondary segment 104(2) extends at least outwardly from the primary segment 104(1) in the vertical direction V1. For instance, in one embodiment, the secondary segment 104(2) extends both increasingly outwardly in the radial direction and increasingly outwardly (e.g., upwardly) in the vertical direction V1 from the primary segment 104(2). Similarly, the third segment 104(3) extends at least outwardly from the primary segment 104(1) in the vertical direction V1. For instance, the third segment 104(3) extends increasingly radially inwardly from the secondary segment 104(2) in the radial direction relative to the second rotational axis 104A and increasingly outwardly (e.g., upwardly) in the vertical direction V1 from the secondary segment 104(2). In one embodiment, the transition between the secondary segment 104(2) and the third segment 104(3) of the second support arm 104 is the furthest portion of the second support arm 104 in the radial direction from the second rotational axis 104A. It should be appreciated that “substantially in the radial direction” herein means more in the radial direction than in the vertical direction V1, or only in the radial direction.

Generally, the primary segment 104(1) of the second support arm 104 is longer than the primary segment 102(1) of the first support arm 102. Further, the proximal end 102P of the first support arm 102 is positioned closer than the proximal end 104P of the second support arm 104 to the control armrest 80C in the vertical direction V1. The secondary segment 102(2) of the first support arm 102 generally extends closer than the secondary segment 104(2) of the second support arm 104 in the radial direction relative to the second rotational axis 104A where the secondary segment 102(2) of the first support arm 102 vertically overlaps with the secondary segment 104(2) of the second support arm 104 in the vertical direction V1. Additionally, the distal end 104D of the second support arm 104 is generally spaced apart from (e.g., higher than) the distal end 102D of the first support arm 102 in the vertical direction V1 relative to the control arm 80C. For instance, in one embodiment, the third segment 104(3) of the second support arm 104 is spaced apart from (e.g., higher than) the secondary segment 102(2) of the first support arm 102 in the vertical direction V1. It should be appreciated that the support arms 102, 104 may have any other suitable number of segments and/or any other suitable shape that allows the first support arm 102 to be positioned radially within the second support arm 104 relative to the second rotational axis 104A.

The system 100 may be configured such that the display screens 82D, 106D, 108D do not overlap along the vertical direction V1 so that the display screens 82D, 106D, 108D are visible in any position of the arms 102, 104 about the rotational axes 102A, 104A. For instance, as shown in FIGS. 3A-4C, the bottom of the display screen 82D is spaced apart from a top of the second display screen 108D in the vertical direction V1, and the bottom of the second display screen 108D is also spaced apart from a top of the first display screen 106D in the vertical direction V1. As particularly shown in FIGS. 4A-4C, the distal end 102D of the first support arm 102 extends at a first height 102H above the primary segment 104(1) of the second support arm 104 in the vertical direction V1, the distal end 104D of the second support arm 104 extends at a second height 104H above the primary segment 104(1) of the second support arm 104 in the vertical direction V1, and the display screen 82D is coupled to the pillar 24P1 (not shown) at a third height 82H above the primary segment 104(1) of the second support arm 104 in the vertical direction V1, where the second height 104H is greater than the first height 102H, and the third height 82H is greater than the second height 104H. Preferably, the difference between the first and second heights 102H, 104H is greater than or equal to the sum of the distance between the distal end 102D of the first support arm 102 and a top edge of the first display screen 106D and the distance between the distal end 104D of the second support arm 104 and a bottom edge of the second display screen 108D. Similarly, the difference between the second and third heights 104H, 82H is preferably greater than or equal to the sum of the distance between the distal end 104D of the second support arm 104 and the top edge of the second display screen 108D and the distance between the mounting location of the display screen 82D and the bottom edge of the display screen 82D. It should be appreciated that, in some embodiments, the entire display units 82, 106, 108 are spaced apart along the vertical direction V1 instead of just the corresponding display screens 82D, 106D, 108D, which may be particularly preferable when the display units 82, 106, 108 have input devices (e.g., buttons, knobs, and/or the like) or indicators (e.g., lights) outside of the display screens 82D, 106D, 108D.

It should be appreciated that, in one embodiment, the support arms 102, 104 each have a respective fixed length. For instance, the first support arm 102 has a first fixed length defined between the proximal end 102P and the distal end 102D, and the second support arm 104 has a second fixed length defined between the proximal end 104P and the distal end 104D, where the second fixed length is longer than the first fixed length. For instance, the segments 102(1), 102(2) of the first support arm 102 may not be retractable or extendable relative to each other, and similarly, the segments 104(1), 104(2), 104(3) of the second support arm 104 may not be retractable or extendable relative to each other. However, in other embodiments, the first support arm 102 and/or the second support arm 104 does not have a fixed length (e.g., may be extendable/retractable) to an extent that still prevents the display units 82, 106, 108 from accidentally contacting each other and/or prevents the screens 82D, 106D, 108D from overlapping along the vertical direction V1. Further, in some embodiments, the support arms 102, 104 are not flexible or flexibly jointed, such that the display units 82, 106, 108 are prevented from accidentally contacting each other and/or such that the displays 82D, 106D, 108D are prevented from overlapping along the vertical direction V1. However, it should be appreciated that, in some embodiments, the support arm(s) 102, 104 may have a limited amount of flexibility that prevents the display units 82, 106, 108 from accidentally contacting each other and the displays 82D, 106D, 108D from overlapping.

The first and second rotational axes 102A, 104A may be configured in multiple ways. For instance, as shown in FIGS. 2, 3A, 4A, and 5A, the first and second rotational axes 102A, 104A are coincident. For instance, the proximal ends 102P, 104P of the support arms 102, 104 are rotatably coupled to the control armrest 80C at the same location. In other embodiments, as shown in FIGS. 4B and 5B, the rotational axes 102A, 104A are spaced apart by a distance D1 along a length of the control armrest 80C (e.g., along the direction of travel 18) such that the first rotational axis 102A is closer than the second rotational axis 104A to a front end of the control armrest 80C along the direction of travel 18. In some embodiments, as shown in FIGS. 4C and 5C, the rotational axes 102A, 104A are spaced apart by a distance D2 (FIG. 5C) along a width of the control armrest 80C (e.g., along a lateral direction LT1, perpendicular to the direction of travel 18) such that one of the rotational axes 102A, 104A is closer than the other of the rotational axes 102A, 104A to the seat 80S of the operator chair 80. For instance, as shown in FIG. 5C, the first rotational axis 102A is closer than the second rotational axis 104A to the seat 80S of the operator chair 80 in the lateral direction LT1.

When the rotational axes 102A, 104A are spaced apart by the distance D1 and/or the distance D2, the lengths of one or more of the segments of the support arm(s) 102, 104 may be adjusted to ensure that the support arms 102, 104 do not contact each other during rotation about the axes 102A, 104A. For instance, the length of the primary segment 102(1) of the first support arm 102 in the radial direction relative to the first rotational axis 102A and/or the length of the primary segment 104(1) of the second support arm 104 in the radial direction relative to the second rotational axis 104A may be adjusted to account for the distance D1, D2 (or the sum of the distances D1, D2). Generally, the difference in length of the primary segments 102(1), 104(1) of the support arms 102, 102 is increased by at least the distance D1, D2 (or the sum of distances D1, D2). For example, the length of the primary segment 104(1) of the second support arm 104 may be increased by the distance D1, D2 (or the sum of the distances D1, D2) in the radial direction relative to the second rotational axis 104A, compared to the length of the primary segment 104(1) when the axes 102A, 104A are coincident as in FIG. 4A, while the length of the primary segment 102(1) of the first support arm 102 in the radial direction relative to the first rotational axis 102A is the same or reduced, compared to the length of the primary segment 102(1) when the axes 102A, 104A are coincident as in FIG. 4A, to account for the spacing between the rotational axes 102A, 104A. Alternatively, the length of the primary segment 102(1) of the first support arm 102 in the radial direction relative to the first rotational axis 102A may be reduced by the distance D1, D2 (or the sum of the distances D1, D2), while the length of the primary segment 104(1) of the second support arm 104 in the radial direction relative to the second rotational axis 104A may be the same or increased, compared to the length of the primary segment 104(1) when the axes 102A, 104A are coincident as in FIG. 4A.

It should be appreciated that the configuration of the support arms 102, 104 allows the first support arm 102 to rotate about the first rotational axis 102A along a first path 110 and the second support arm 104 to rotate about the second rotational axis 104A along a second path 112, independently of rotation of the first support arm 102 along the first path 110, without interfering with the first support arm 102. The paths 110, 112 generally follow the radially outermost portion of the support arms 102, 104 at each position along the vertical direction V1 as the support arms 102, 104 rotate about the axes 102A, 104A. In FIGS. 5A-5C, only the portions of the paths 110, 112 at the height 102H above the primary segment 104(1) of the second support arm 104 are shown. However, it should be appreciated that the portions of the paths 110, 112 for any other position in the vertical direction V1 associated with the first support arm 102 are substantially similarly oriented relative to each other as in FIGS. 5A-5C. As particularly shown in FIG. 5A, the rotational axes 102A, 104A are coincident and the paths 110, 112 are thus, correspondingly concentric. As shown in FIG. 5B, the rotational axes 102A, 104A are spaced apart along the direction of travel 18 by the distance D1 and thus, the paths 110, 112 are not concentric. Similarly, in FIG. 5C, the rotational axes 102A, 104A are spaced apart along the lateral direction LT1 by the distance D1 and thus, the paths 110, 112 are not concentric. In each of FIGS. 5A-5C, the radius of the first path 110 is smaller than the radius of the second path 112, and the entire first path 110 is spaced radially inwardly from the second path 112 relative to the second rotational axis 104A. In other words, the first support arm 102 is spaced apart from the second support arm 104 at each position of the first support arm 102 along the first path 110 and each position of the second support arm 104 along the second path 112, with the first path 110 being closer than the second path 112 to the second rotational axis 104A in the radial direction relative to the second rotational axis 104A.

It should be appreciated that, while the system 100 is shown as having only two support arms 102, 104, the system 100 may have any other suitable number of support arms, such as three or more support arms, where the support arms may still have non-intersecting travel paths (like the travel paths 110, 112) and support display units without overlapping the corresponding display screens in the vertical direction V1 (like the display screens 82D, 106D, 108D). It should additionally be appreciated that the support arms 102, 104 may instead be rotatably coupled to any other suitable base support within the cab 24, such as the floor 24F.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

1. A system for mounting multiple displays within a cab of an agricultural work vehicle, the system comprising:
a base support positioned within the cab;
a first support arm extending between a first proximal end and a first distal end, the first proximal end being rotatably coupled to the base support about a first axis;
a second support arm extending between a second proximal end and a second distal end, the second proximal end being rotatably coupled to the base support about a second axis, the second support arm being rotatable about the second axis along a second path independently of rotation of the first support arm about the first axis along a first path, the entire first path being spaced radially inwardly from the second path relative to the second axis such that the first support arm and the second support arm may move past each other without interfering with each other at any point along their travel paths;
a first display coupled to the first distal end of the first support arm relative to the base support; and
a second display coupled to the second distal end of the second support arm relative to the base support.

2. The system of claim 1, wherein the first support arm has a first fixed length defined between the first proximal end and the first distal end, and the second support arm has a second fixed length defined between the second proximal end and the second distal end.

3. The system of claim 1, wherein the first proximal end of the first support arm is closer to the base support than the second proximal end of the second support arm.

4. The system of claim 1, wherein the second distal end is further from the base support than the first distal end in a vertical direction such that the first display is spaced apart from the second display in the vertical direction.

5. The system of claim 1, wherein the first axis and the second axis are coincident.

6. The system of claim 1, wherein the first axis is spaced apart from and parallel to the second axis.

7. The system of claim 1, wherein the first axis and the second axis are parallel to a vertical direction.

8. The system of claim 1, wherein the first support arm is spaced apart from the second support arm at each position of the first support arm along the first path and each position of the second support arm along the second path.

9. (canceled)

10. (canceled)

11. (canceled)

12. (canceled)

13. The system of claim 1, wherein the first support arm extends increasingly radially outwardly from the first proximal end to the first distal end.

14. The system of claim 1, wherein the first support arm has a first primary segment and a first secondary segment, the first primary segment extending between the first proximal end and the first secondary segment, the first secondary segment extending between the first primary segment and the first distal end, the first primary segment extending substantially along a radial direction, the first secondary segment extending outwardly from the first primary segment in the radial direction and in a vertical direction, and
wherein the second support arm has a second primary segment and a second secondary segment, the second primary segment extending between the second proximal end and the second secondary segment, the second primary segment extending substantially along the radial direction, the second secondary segment extending outwardly from the second primary segment in the radial direction and in the vertical direction,
wherein the second primary segment is longer than the first primary segment in the radial direction.

15. The system of claim 14, wherein the second support arm further has a third segment, the third segment extending inwardly from the second secondary segment in the radial direction and away from the second secondary segment in the vertical direction.

16. An agricultural vehicle, comprising:
a cab;
a base support positioned within the cab;
a first support arm extending between a first proximal end and a first distal end, the first proximal end being rotatably coupled to the base support about a first axis;
a second support arm extending between a second proximal end and a second distal end, the second proximal end being rotatably coupled to the base support about a second axis, the second support arm being rotatable about the second axis along a second path independently of rotation of the first support arm about the first axis along a first path, the entire first path being spaced radially inwardly from the second path relative to the second axis;
a first display coupled to the first distal end of the first support arm relative to the base support; and
a second display coupled to the second distal end of the second support arm relative to the base support.

17. The agricultural vehicle of claim 16, wherein the first axis and the second axis are coincident.

18. The agricultural vehicle of claim 16, wherein the first axis is spaced apart from and parallel to the second axis.

19. The agricultural vehicle of claim 16, further comprising an operator chair within the cab, the operator chair having an arm,
wherein the base support is the arm of the operator chair.

20. The agricultural vehicle of claim 16, further comprising a further display,
wherein the cab includes a floor and a roof supported above the floor by a structural pillar,
wherein the further display is supported on the structural pillar, and
wherein the first display and the second display are spaced apart from the further display in a vertical direction.

21. A system for mounting multiple displays within a cab of an agricultural work vehicle, the system comprising:
a base support positioned within the cab, the base support being an arm of a chair within the cab;
a first support arm extending between a first proximal end and a first distal end, the first proximal end being rotatably coupled to the base support about a first axis;
a second support arm extending between a second proximal end and a second distal end, the second proximal end being rotatably coupled to the base support about a second axis, the second support arm being rotatable about the second axis along a second path independently of rotation of the first support arm about the first axis along a first path, the entire first path being spaced radially inwardly from the second path relative to the second axis;
a first display coupled to the first distal end of the first support arm relative to the base support; and
a second display coupled to the second distal end of the second support arm relative to the base support.

22. A system for mounting multiple displays within a cab of an agricultural work vehicle, the system comprising:
a base support positioned within the cab;
a first support arm extending between a first proximal end and a first distal end, the first proximal end being rotatably coupled to the base support about a first axis;
a second support arm extending between a second proximal end and a second distal end, the second proximal end being rotatably coupled to the base support about a second axis, the second support arm being rotatable about the second axis along a second path independently of rotation of the first support arm about the first axis along a first path, the entire first path being spaced radially inwardly from the second path relative to the second axis;
a first display coupled to the first distal end of the first support arm relative to the base support;
a second display coupled to the second distal end of the second support arm relative to the base support; and
a further display supported within the cab on a structural pillar of the cab, the first display and the second display being spaced apart from the further display in a vertical direction.
